(19) United States
(12) Patent Application Publication
(10) Pub. No.: US 2013/0273510 A1
(43) Pub. Date: Oct. 17, 2013

(54) Handwriting method for teaching roman alphabet

(71) Applicant: Matthew Cooper, Louisville, KY (US)

(72) Inventor: Matthew Cooper, Louisville, KY (US)

(21) Appl. No.: 13/815,228

(22) Filed: Feb. 11, 2013

Related U.S. Application Data
(60) Provisional application No. 61/633,378, filed on Feb. 10, 2012.

(51) Int. Cl. G09B 11/00

(52) U.S. Cl. CPC G09B 11/00
USPC 434/162

(57) ABSTRACT

A muscle movement handwriting teaching method for teaching handwriting using a novel lettering guide and an method of instruction which takes advantage of the similar hand movements used with-in particular groups of letters. The learning of these letters is organized so that after one letter is mastered, another letter is learned based on the similarities of hand movements used in printing a learned letter and the next letter being taught. The handwriting method facilitates learning how to read and write in new languages.

### CROSS-REFERENCE TO RELATED APPLICATIONS

This application claims priority from U.S. Provisional application Ser. No. 61/633,378 filed on Feb. 10, 2012 and U.S. Provisional application Ser. No. ______ filed simultaneously herewith on Feb. 11, 2013 both of which are incorporated by reference herein in their entirety. Reference to documents made in the specification is intended to result in such patents or literature cited are expressly incorporated herein by reference, including any patents or other literature references cited within such documents as if fully set forth in this specification.

### TECHNICAL FIELD

The present invention relates to the field of teaching students to print using the Roman alphabet wherein the method is applicable to the use of other alphabets in order to learn to read and write other languages.

### BACKGROUND OF THE INVENTION

The ability to read or to write in a particular language such as English hinges on one's ability to recognize and print all of the letters, for instance in English, the Roman alphabet. The method of constructing the symbols or letters of a particular language have a great impact on the ease or difficulty of learning that series of symbols.

For instance, two fundamental features about the Roman alphabet are critical to the ease of learning how to construct the letters and words. The first simple but crucial observation is that teaching the letters in the traditional, “alphabetical” order has no rationale from the point of view of the specific hand-motion skills required in order to write them. The alphabet is arranged in the standard /a-b-c/ order for merely historical reasons, dating back to its origins in the Eastern Mediterranean several millennia ago. But for the modern student who simply needs to learn how to write, and therefore also to read the letters of the alphabet with ease and fluency, there is no justification for learning them in their historical order.

A second crucial observation is that, for the purpose of making letters much easier for the student to acquire the ability to form on paper accurately and confidently in a considerably shorter period of time, the actual movement of the pen or pencil point in the process of writing each letter is an important consideration in establishing an efficient method to learn the alphabet and words created therefrom. With respect to use of the letters of the Roman alphabet it has been an unexpected surprise to find that the letters can be arranged into four clear groups based on nothing more than the initial direction of motion of writing the letters. This new method of teaching students how to print the Roman alphabet letters is based on teaching the letters in these four groups, one group at a time.

Children have been taught to print in the past by learning to print the letters starting with the letter ‘a’ and proceeding to ‘z’ alphabetically. There are two fundamental features about the Roman alphabet which have a great impact on the ease or difficulty of learning that series of symbols. The first simple but crucial observation is that teaching the letters in the traditional, alphabetical” order has no rationale from the point of view of the specific hand-motion skills required in order to write them. The alphabet is arranged in the standard /a-b-c/ order for merely historical reasons, dating back to its origins in the Eastern Mediterranean several millennia ago. But for the modern student who simply needs to learn how to write, and therefore also to read, the letters of the alphabet with ease and fluency, there is no justification for learning them in their historical order.

### SUMMARY OF THE INVENTION

A muscle movement handwriting teaching method for teaching handwriting using a novel lettering guide and an method of instruction which takes advantage of the similar hand movements used with-in particular groups of letters. The learning of these letters is organized so that after one letter is mastered, another letter is learned based on the similarities of hand movements used in printing a learned letter and the next letter being taught. The handwriting method facilitates learning how to read and write in new languages. Thus, the muscle movement handwriting method provides a lettering guide and method of teaching, the printing of the Roman alphabet which takes advantage of the similar hand movements used in printing letters with-in particular groups and therefore teaches the letters in groupings which are grouped based on the shape of the letters within each group.

The learning of these letters is organized so that after the simplest letter in the group is mastered, another letter is learned based on the similarities of hand movements used in printing a learned letter and the next letter being taught. The teaching of printing is also aided with the use of a novel lettering guide which includes shaded guidelines on lined paper which contain the all of the curved and straight parts of a selected letter being taught.

Therefore, for the purpose of making them much easier for the student to acquire the ability to form the letters on paper accurately and confidently in a considerably shorter period of time. The actual movement of the pen or pencil point in the process of writing each letter was studied and it was found that all the letters of the Roman alphabet can be arranged into four clear groups based on nothing more than the initial direction of motion.

These groups are as follows:

The first group is designated as the “flying Letters, so named because the initial movement resembles that of an object flying through the air. This group can also be arranged among themselves based on increasing complexity of movement. The order of these eight letters, then, is /c-o-a-d-g-q-s-f/, since /c/ is the simplest, with /o/ being only a slight continuation of the movement of the /c/, and then the letter /a/ following from the motion of the /o/, and so on, each successive letter building on and modifying the pattern of the one before it in the new arrangement of letters. In this way, the student can learn to write these eight letters much more quickly than otherwise because the challenges required of the muscles and the brain in the complicated task of eye/hand coordination are significantly reduced. Also, because it is so clear how the process of writing each successive letter follows naturally from the previous one, the student faces far less confusion and complexity than if the letters were learned in the normal /a-b-c/ order, which has a chaotic mixture of initial movements. This becomes even clearer when the next series of letters are examined.

The second group is designated as the “falling letters” since their initial movement resembles that of an object falling straight down. Like the first group, these twelve letters can also be arranged somewhat based on increasing complexity, as well as height, since there are two clear subcategories of tall and short letters, as follows: /l-h-b-t-k/ in the tall category, and /p-r-n-m-u-i-j/ in the short category.

The third group has only four letters, and may be called the “sloping letters” since their initial movement is that of a line sloping at an angle downward and to the right. They are already conveniently arranged in a reasonably logical order from the point of view of learning to write them, moving from simple to complex: /v-w-x-y/.

The last fourth group can be called the ‘sliding letters” because the initial movement is that of an object sliding horizontally to the right. They are /e-z/.

The names of the groups, “flying”, “falling”, “sloping”, and “sliding” also help the student as an easy mnemonic device to organize and simply in the mind the otherwise far more chaotic and random-seeming arrangement of the letters in their usual order from /a/ to /z/. Students are taught the mechanics of writing the letters through this modified arrangement of: /c-o-a-d-g-q-s-f-l-h-b-t-k-p-r-n-m-u-I-j-v-w-x-y-e-z/ without necessarily emphasizing or even bringing that arrangement to their attention. It is simply the order in which the letters will be studied, one by one, for the purpose of mastering the challenges of writing. This order of the letters has no further purpose. Once the students is comfortable and familiar with the letters, their names and sounds and their use in a small selection of sample words, their increased level of comfort and familiarity will actually make it easier for them to go on to memorize the traditional order of letters, as set forth below: /a-b-c-d-e-f-g-h-I-j-k-l-m-n-o-p-q-r-s-t-u-v-w-x-y-z/ which they will need in order to look up words in a dictionary, find things in alphabetized lists, and be able to do various types of office work that require alphabetizing materials.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 shows a matrix using 3 circles and 2 vertical lines;

FIG. 2 shows a plurality of the matrix of FIG. 1 superimposed on a number of light blue lines and a red line in order to aid alignment of multiple letters;

FIG. 3 shows the matric of FIG. 1 and horizontal lines with red dots superimposed to show a starting point of the construction of a letter;

FIG. 4 shows the matric of FIG. 3 with horizontal lines, and red dot superimposed upon said matrix depicting the actual shape of a letter;

FIG. 5 shows the matrix of FIG. 4 including horizontal lines, a red dot, the actual shape of a letter and arrow indicating direction of motion;

FIG. 6 shows the matrix of FIG. 5 showing an arrow indicating the direction of motion, the horizontal lines and red dot without the shape of the letter;

FIG. 7 shows a matrix wherein the circle and vertical lines are depicted as light gray in step 1;

FIG. 8 shows a matrix superimposed on a number of light blue lines and a red line in order to aid alignment of multiple letters in step 2;

FIG. 9 shows a matrix and horizontal lines with a red dot superimposed to show starting point in step 3;

FIG. 10 shows a matrix with horizontal lines, a red dot, and actual shape of a letter in step 4;

FIG. 11 shows a matrix, horizontal lines, a red dot, an actual shape of a letter, and an arrow in step 5;

FIG. 12 shows a matrix with horizontal lines, a red dot, and an arrow without the shape of the letter in step 6;

FIG. 13 shows a matrix with horizontal lines, an arrow without the shape of the letter wherein the red dot has been removed in step 7;

FIG. 14 shows a spaced apart red and light blue horizontal lines for use with the matrix in step 8;

FIG. 15 is shows the legend for the figures depicting the basic elements for the muscle movement system for teaching handwriting set forth with indicia representing the colors and geometric elements used for the matrix and for building the letters thereon;

FIG. 16 shows the steps of constructing the letter “a” using the lettering guide;

FIG. 17 shows the steps of constructing the letter “b” using the lettering guide;

FIG. 18 shows the steps of constructing the letter “c” using the lettering guide;

FIG. 19 shows the steps of constructing the letter “d” using the lettering guide;

FIG. 20 shows the steps of constructing the letter “e” using the lettering guide;

FIG. 21 shows the steps of constructing the letter “f” using the lettering guide;

FIG. 22 shows the steps of constructing the letter “g” using the lettering guide;

FIG. 23 shows the steps of constructing the letter “h” using the lettering guide;

FIG. 24 shows the steps of constructing the letter “I” using the lettering guide;

FIG. 25 shows the steps of constructing the letter “j” using the lettering guide;

FIG. 26 shows the steps of constructing the letter “k” using the lettering guide;

FIG. 27 shows the steps of constructing the letter “l” using the lettering guide;

FIG. 28 shows the steps of constructing the letter “m” using the lettering guide;

FIG. 29 shows the steps of constructing the letter “n” using the lettering guide;

FIG. 30 shows the steps of constructing the letter “o” using the lettering guide;

FIG. 31 shows the steps of constructing the letter “p” using the lettering guide;

FIG. 32 shows the steps of constructing the letter “q” using the lettering guide;

FIG. 33 shows the steps of constructing the letter “r” using the lettering guide;

FIG. 34 shows the steps of constructing the letter “s” using the lettering guide;

FIG. 35 shows the steps of constructing the letter “t” using the lettering guide;

FIG. 36 shows the steps of constructing the letter “u” using the lettering guide;

FIG. 37 shows the steps of constructing the letter “v” using the lettering guide;

FIG. 38 shows the steps of constructing the letter “w” using the lettering guide;

FIG. 39 shows the steps of constructing the letter “x” using the lettering guide;

FIG. 40 shows the steps of constructing the letter “y” using the lettering guide;

FIG. 41 shows the steps of constructing the letter “z” using the lettering guide;

### DESCRIPTION OF THE PREFERRED EMBODIMENTS

In accordance with the present invention, there is provided a method of teaching the printing of Roman alphabet. The method is based on grouping the letters into four groups based on the initial direction of motion of the pen when making the letters. This group can be arranged among themselves based on increasing complexity of movement. All the letters of the Roman alphabet can be arranged into four clear groups based on nothing more than the initial direction of motion for the following patterns: 1) around, 2) down, 3) diagonal to right, and 4) horizontal to right.

The first group designated: the “flying Letters, is so named because the initial movement resembles that of an object flying through the air. This group can also be arranged among themselves based on increasing complexity of movement. The order of these eight letters, then, is /c-o-a-d-g-q-s-f/, since /c/ is the simplest, with /o/ being only a slight continuation of the movement of the /c/, and then the letter /a/ following from the motion of the /o/, and so on, each successive letter building on and modifying the pattern of the one before it in the new arrangement of letters.

In this way, the student can learn to write these eight letters much more quickly than otherwise because the challenges required of the muscles and the brain in the complicated task of eye/hand coordination are significantly reduced. Also, because it is so clear how the process of writing each successive letter follows naturally from the previous one, the student faces far less confusion and complexity than if the letters were learned in the normal /a-b-c/ order, which has a chaotic mixture of initial movements.

This becomes even clearer when the next series of letters are examined. The second group is designated as the “falling letters” since their initial movement resembles that of an object falling straight down. Like the first group, these twelve letters can also be arranged somewhat based on increasing complexity, as well as height, since there are two clear subcategories of tall and short letters, as follows: /l-h-b-t-k/ in the tall category, and /p-r-n-m-u-I-j/ in the short category.

The third group has only four letters, and may be called the “sloping letters” since their initial movement is that of a line sloping at an angle downward and to the right. They are already conveniently arranged in a reasonably logical order from the point of view of learning to write them, moving from simple to complex: /v-w-x-y/.

The fourth and final group can be called the ‘sliding letters” because the initial movement is that of an object sliding horizontally to the right. They are /e-z/.

The names of the groups, “flying”, “falling”, “sloping”, and “sliding” also help the student as an easy mnemonic device to organize and simply in the mind the otherwise far more chaotic and random-seeming arrangement of the letters in their usual order from /a/ to /z/. Students will be taught the mechanics of writing the letters through this modified arrangement of

/c-o-a-d-g-q-s-f-l-h-b-t-k-p-r-n-m-u-I-j-v-w-x-y-e-z/

without necessarily emphasizing or even bringing that arrangement to their attention. It is simply the order in which the letters will be studied, one by one, for the purpose of mastering the challenges of writing. This order of the letters has no further purpose than that. Once the students have become comfortable and familiar with the letters, their names and sounds and their use in a small selection of sample words, their increased level of comfort and familiarity will actually make it easier for them to go on to memorize the traditional order of letters, as below,

/a-b-c-d-e-f-g-h-I-j-k-l-m-n-o-p-q-r-s-t-u-v-w-x-y-z/

which they will need in order to look up words in a dictionary, find things in alphabetized lists, and be able to do various types of office work that require alphabetizing materials.

In addition to the re-arrangement of the order of the letters in this system of teaching handwriting, the second fundamental observation is that the Roman alphabet has evolved to fit very neatly and consistently into a simple pattern of circles, straight lines, and dots. This high degree of conformity to these three shapes makes it possible to put all the letters onto a very simple matrix consisting of three circles set between two vertical lines, superimposed over the four traditional guidelines used for handwriting practice, as seen in the Figures.

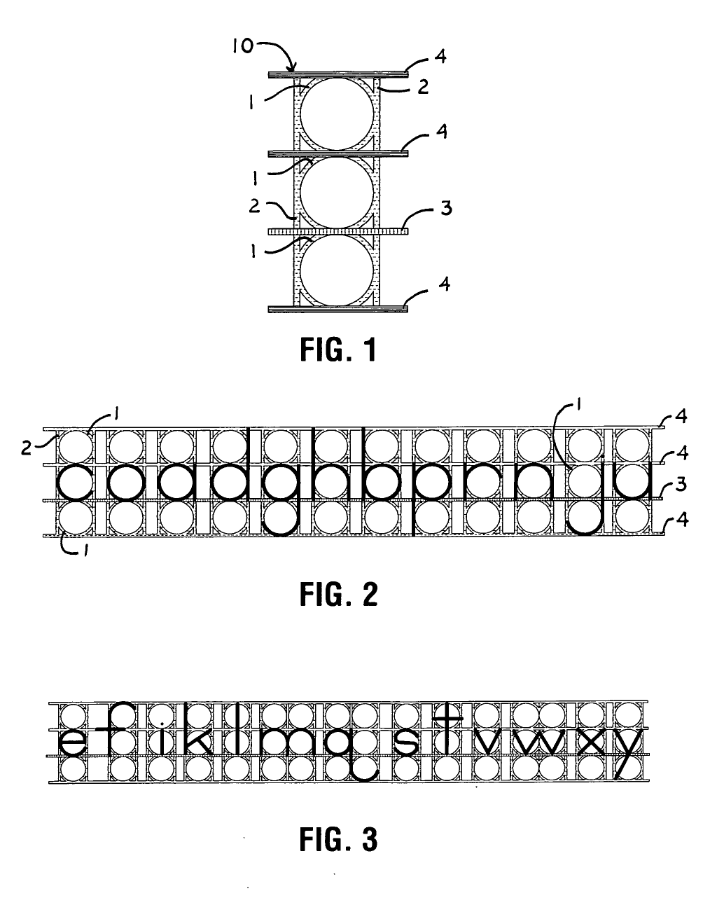

FIG. 1 shows a legend depicting the elements of the drawings comprising the matrixes. The light gray circle 12 is used in combination with light grey vertical lines 14 to construct the matrix 10. FIG. 1 shows a matrix 10 using 3 circles 12 and two vertical lines 14.

FIG. 2 shows a plurality of a larger matrix 100 comprising a row of three circles 12 including a lower row 18, middle row 20, and top row 22 set between vertical lines 14 with three columns of circles 12 including a left column 24, middle column 26, and right column 28. A horizontal red line 29 is disposed at a selected position between the lower row 18 and middle row 20. Light blue lines horizontal lines 30 are disposed at the bottom or the lower row 18 and between the middle row 22 and top row 22, and above the top row 22. The horizontal red line lines 29 and the blue lines 30 aid in alignment of the letters within the matrix. Superimposing the matrix on a number of light blue lines and a red line aids in alignment of multiple letters.

FIG. 3 shows the matric of FIG. 1 and horizontal lines with red dots superimposed to show a starting point of the construction of a letter;

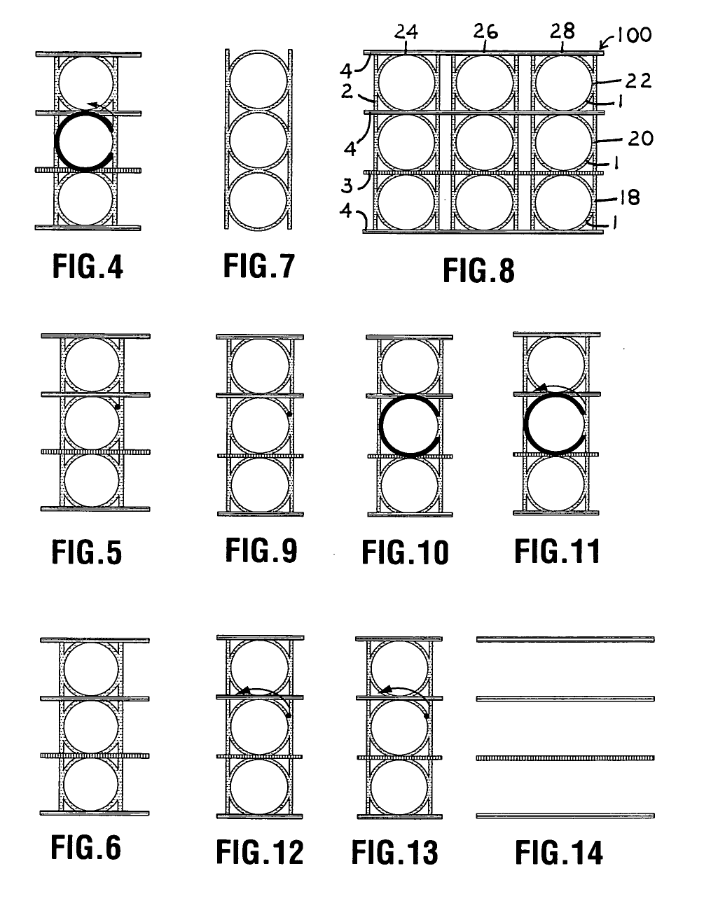

FIG. 4 shows the matric of FIG. 3 with horizontal lines, and red dot superimposed upon said matrix depicting the actual shape of a letter;

FIG. 5 shows the matrix of FIG. 4 including horizontal lines, a red dot, the actual shape of a letter and arrow indicating direction of motion;

FIG. 6 shows the matrix of FIG. 5 showing an arrow indicating the direction of motion, the horizontal lines and red dot without the shape of the letter;

All of the following letters can be placed precisely over this matrix, without leaving the guidance of the circles or the lines at all.

All the other letters can still be placed over the matrix with only a few modifications, while still maintaining the primary benefit of helping the student achieve consistency in size and spacing. These minor modifications to the basic matrix of three circles and two lines are shown below.

Using this matrix as a letter guide, it becomes easier to visualize the letters by giving the brain a consistent/background pattern on which to place the letters. The matrix provides a precise and symmetrical visual template onto which the mind can more easily fix the shapes of the letters. The degree, and therefore the sense, of conformity and predictability of this matrix-based system help the brain to organize and retain the otherwise far more random-seeming and unpredictable shapes of these 26 vital symbols of communication.

Another very important and unique aspect of this system of teaching handwriti [symbol] of five-six steps in the practice procedures, as shown below. Step One offers t [symbol] maximum support in writing the letter, including the background matrix, the startin [symbol] direction of movement.

Step Two increases the difficulty only a small degree, by removing the actu [symbol] letter and the arrow, but leaving the standard matrix and a dot for the starting point.

Step Three increases the difficulty again by only a small increment, by removing the dot that indicates the starting point, while leaving the matrix.

Step Four continues this process of small, incremental increases in the demands on the student's mind by removing the matrix and leaving only the three horizontal lines.

The standard method of teaching handwriting goes directly from Step One to Step Four, without any intermediary assistance to the student, making the process more difficult and intimidating than it needs to be. This expanding and more detailed series of carefully graduated steps is a great help to students in learning to write. The mere fact that each increase in difficulty is so small actually encourages them to proceed from one level to the next with more confidence than if they had to make the leap from the high degree of guidance of Step One to the nearly complete lack of guidance of Step Four.

Furthermore, Step Five arrives at the ultimate challenge by presenting the student with a simple, single horizontal line, shown below, upon which he or she will be required to remember all of the following: the starting point, the initial direction, the size and shape of the letter after beginning in the correct location and going in the right direction, and where to stop. All of these are discrete tasks that the brain has to register and put to use in very rapid succession in order for the student to write even the most basic message, such as his or her own name.

The last feature is the simple use of a clear plastic sheet, such as those used in overhead projectors, that will be included with each book, so that a student can remove the plastic sheet from the book and then place it over any page they may be working on, and use a dry-erase marker or a water-soluble marker, to practice the letters moving through the five steps, just as though they were writing in the book itself. The clear plastic sheet where a student has written their final version of the letter in Step Five, more or less completely on their own, free hand, can then be moved and placed directly over the original shape of the letter in Step One so that the student can see immediately and precisely where the shape they drew deviates from the correct shape, and they can see exactly where they need to improve. This cannot be done when the student write onto the page itself using erasable or washable markers. They can only make a rough comparison between the shape they have drawn in the practice area and the original shape of the letter, several inches away on the page.

In sum, the rearrangement of the order of the letters from the traditional, historical order to one based as closely as possible on the movements of the muscles used in writing them. The use of the simple matrix consisting of three circles and two lines as shown in the drawings. Five to six steps of increasing difficulty are used in the present invention as compared with merely two steps in other conventional writing systems. The use of a movable clear plastic sheet allows the students to superimpose their own letters directly over the original form to make a more precise comparison than would otherwise be possible.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the examples. In the examples all percentage are given on a weight basis unless otherwise indicated.

### Example 1

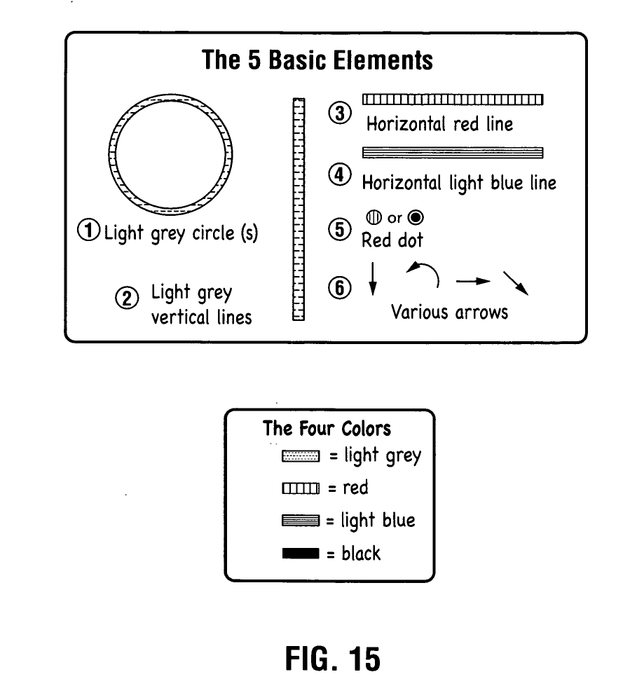

FIG. 15 shows the legend depicting the basic elements for the system for teaching handwriting set forth with indicia representing the colors and geometric elements used for the matrix and for building the letters thereon;

As shown in FIGS. 7-14, the system used five simple steps with each step being just a little more difficult and demanding just a little higher level of skill than the step before. The first step show in FIG. 7 includes five elements: the letter itself, a red dot so show where to start, an arrow for the direction, a grey matrix as a guide for the size and shape, and then three horizontal lines. The second step eliminates only the arrow and the actual shape of the letter; however the student still has the aid of the red dot, the matrix, and the three lines as shown in FIG. 9. In the third step shown in FIG. 13, the red is removed which may seem like a very small change, but it is important because it forces the student to create an image of the letter in his or her own mind. As illustrated in FIG. 14, the fourth step shows a matrix having two upper spaced apart light blue lines over a red horizontal line over a bottom light blue line which causes the student to not only have to memorize the shape of the letter and where to start, but also the order and direction of eh movements. Finally in step five, there is nothing more than a single horizontal line to show where to put the letter. The student must compose the letter without any additional assistance.

### Example 2

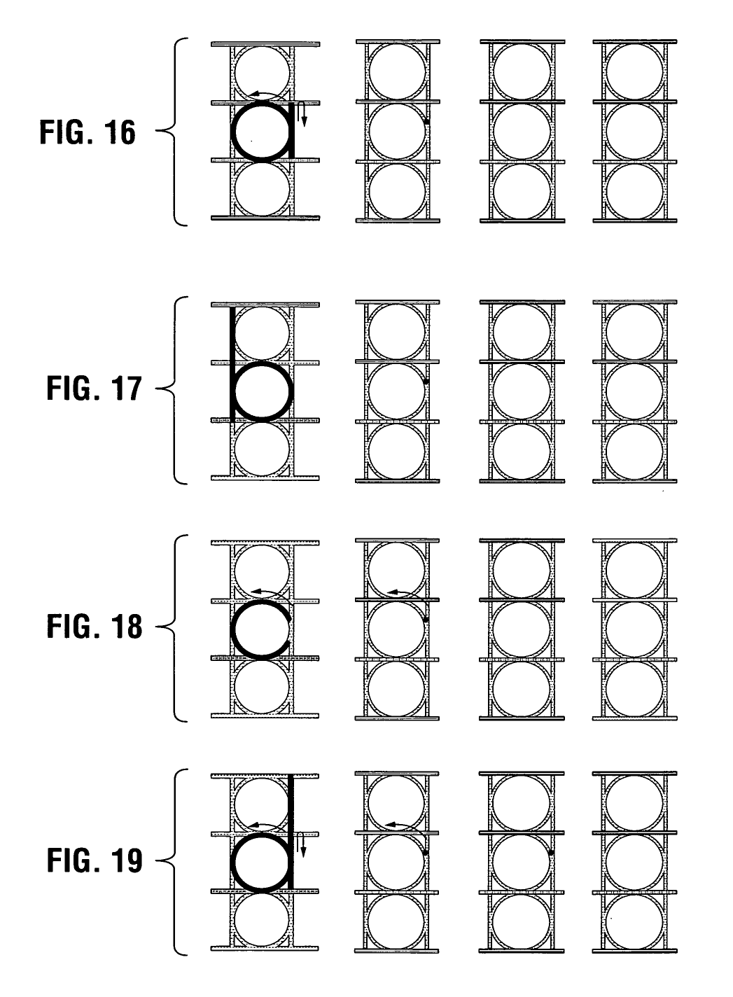

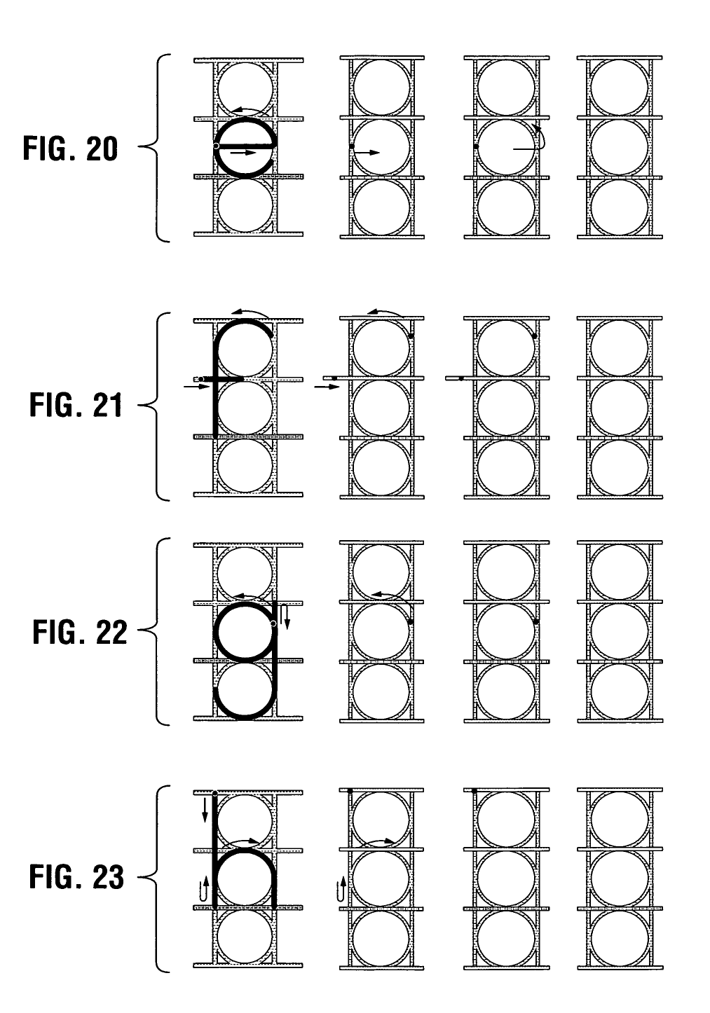

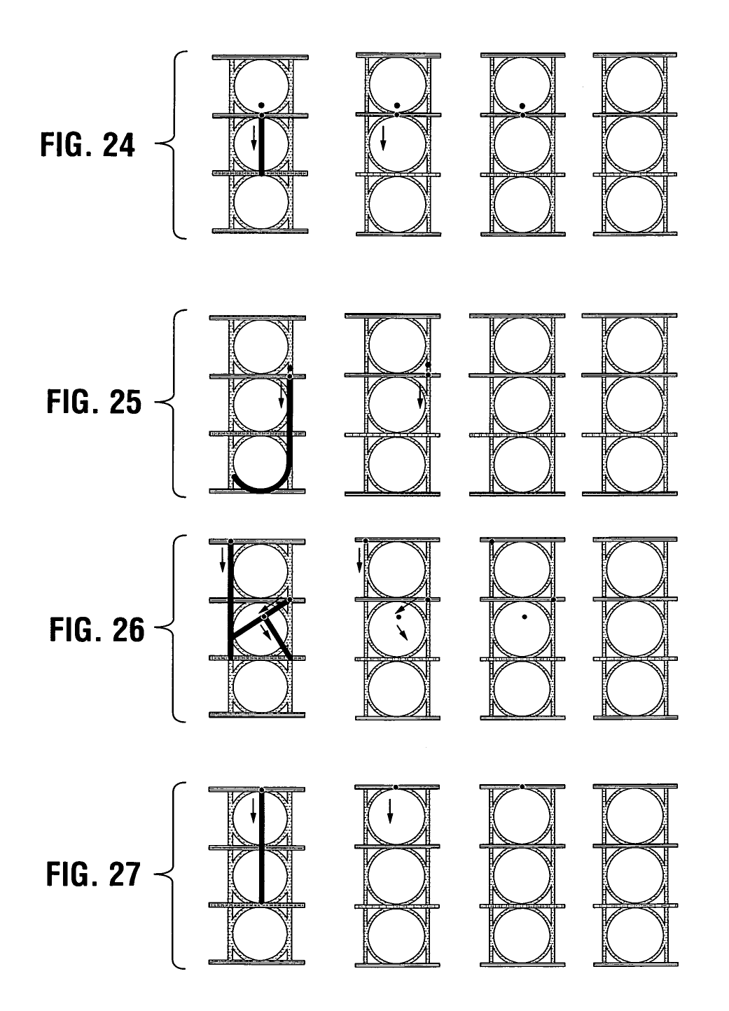

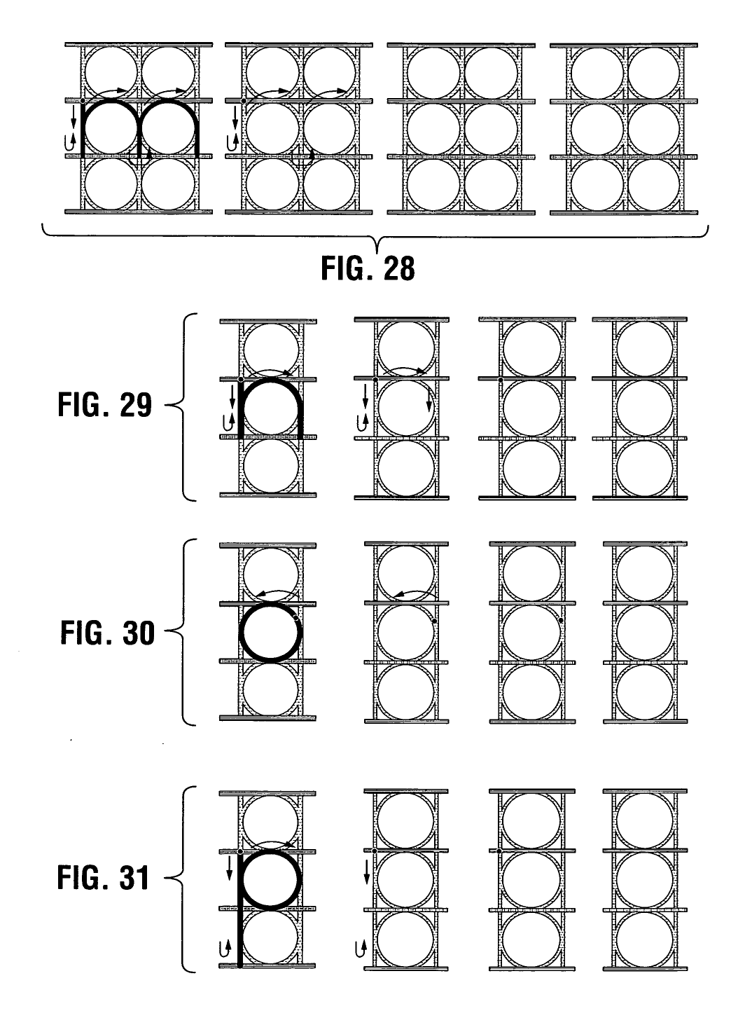

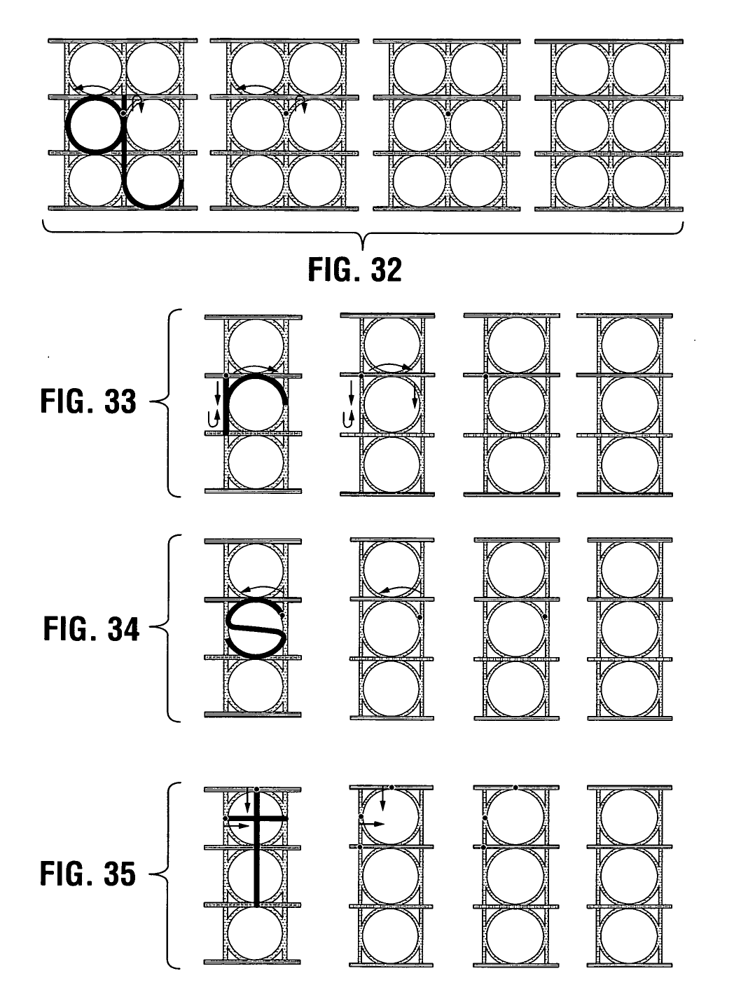

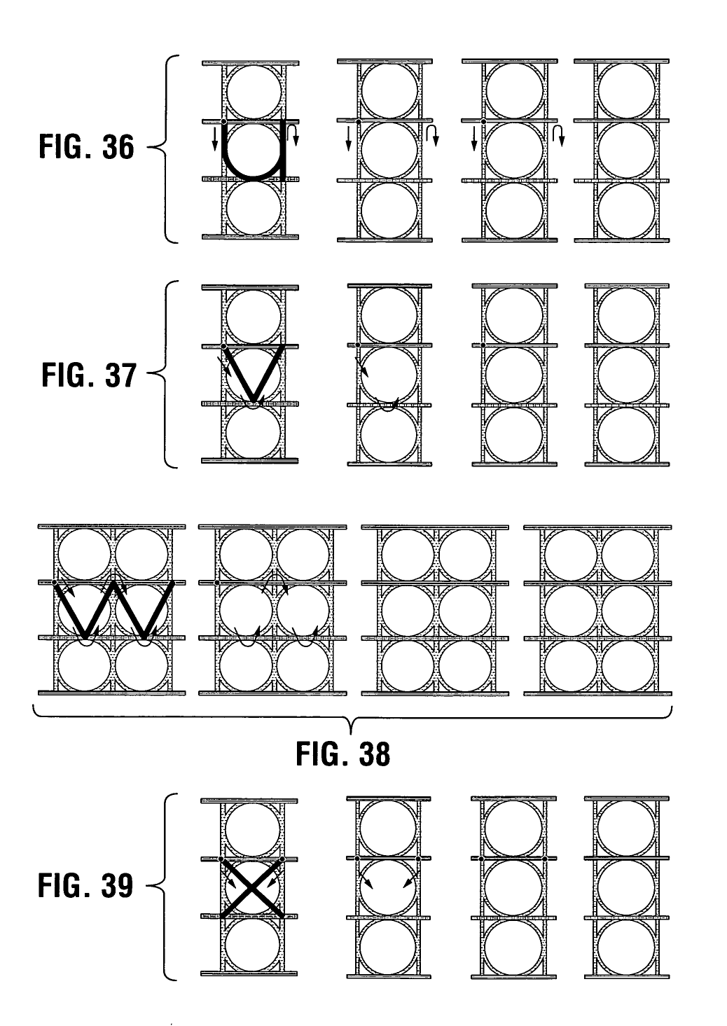

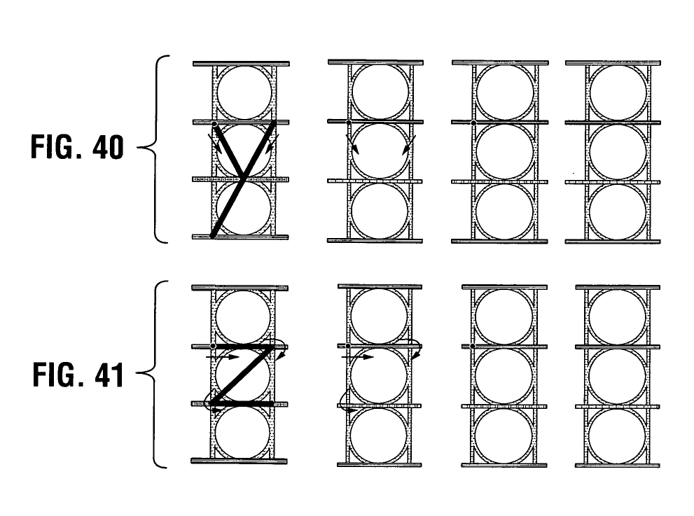

The matrix or grid is shown comprising, consisting essentially of, or consisting of: three light grey circles between two vertical lines superimposed over the traditional four horizontal lines as shown in FIG. 1 (three in light blue and one in red). Then the red dot, the black arrow, the black outline of the letter itself are placed on the matrix as shown for the letters of the alphabet (a-z) in FIGS. 16-41. In step 1, the matrix includes all of the elements including the letter itself in black, the red dot, the arrow in black, the three circles and two vertical lines in light grey, the three horizontal lines in light blue and the horizontal lines in red. In step 2, only the letter is removed from the matrix. In step 3, the arrow is removed from the matrix. In step 4, the red dot is removed from the matrix. Step 5 removes the gray circles and vertical lines. Finally in Step 6, the light blues lines are removed from the matrix.

The six steps shown above represent the maximum level of breakdown in the use of the six elements. In actual use, especially with simpler letters, it may not be necessary to use all six gradual steps. For instance, the removal of these elements can be done two at a time, instead of one at a time, depending on the letter being taught, its's complexity, the level of ability of the students.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A handwriting teaching method comprising the steps of:
a) The first step comprises the rearrangement of the order of the letters from the traditional, historical order (A, B, C, D, E, F, G, H, I, J, K, L, M, N, O, P, Q, R, S, T, U, V, X, Y, Z) to one based as closely as possible on the initial direction of motion and/or the movements of the muscles used in writing said letters comprising the groups of:
1) the flying letters because the initial movement resembles that of an object flying through the air;
2) the falling letters because their initial movement resembles that of an object falling straight down;
3) the sloping letters because their initial movement is that of a line sloping at an angle downward and to the right; and
4) the sliding letters because the initial movement is that of an object sliding horizontally to the right;
b) the second step comprises using a simple matrix consisting of three circles, at least two spaced apart vertical lines, and at least one horizontal line; and
c) the third step comprises five stages of increasing difficulty including:
1) forming a letter using a background matrix as the starting point for the direction of movement and forming the shape of the letter, an arrow indicating direction of movement, and a dot indicating a starting point;
2) increasing the difficulty by only a small degree by forming a letter after removing the actual shape of the letter and the arrow, but leaving the standard matrix and a dot for the starting point;
3) increasing the difficulty again by only a small increment by forming a letter after removing the dot that indicates the starting point, while leaving the matrix; and
4) continuing the process of small, incremental increases in the demands on the student's mind by forming the letter after removing the matrix and leaving only the three horizontal lines; and
5) forming the letter after presenting the student with a simple, single horizontal line, shown below, upon which he or she will be required to remember all of the following: the starting point, the initial direction, the size and shape of the letter after beginning in the correct location and going in the right direction, and where to stop.

2. The handwriting method of claim 1, including the step of using movable clear plastic sheet and superimposing a user's formed letters directly over the original template letters comparing same.

3. The handwriting method of claim 1, wherein said the second step comprises using a matrix consisting of three circles, at least two spaced apart vertical lines, and a selected number of horizontal lines forming letters.
